(19) United States
(12) Patent Application Publication
(10) Pub. No.: US 2006/0230257 A1
(43) Pub. Date: Oct. 12, 2006

(54) System and method of using a predicate value to access a register file

(76) Inventors: Muhammad Ahmed, Austin, TX (US); Erich Plondke, Austin, TX (US); Lucian Codrescu, Austin, TX (US); William C. Anderson, Austin, TX (US)

Correspondence Address: QUALCOMM INCORPORATED, 5775 MOREHOUSE DR., SAN DIEGO, CA, 92121, US

(21) Appl. No.: 11/104,163

(22) Filed: Apr. 11, 2005

(51) Int. Cl. G06F 9/30

(52) U.S. Cl. 712/200

(57) ABSTRACT

A processor device is disclosed and includes a memory unit and at least one interleaved multi-threading instruction pipeline. The interleaved multi-threading instruction pipeline utilizes a number of clock cycles that is less than an instruction issue rate for each of a plurality of program threads that are stored within the memory unit. The memory unit includes six instruction caches. Further, the processor device includes six register files and each of the six register files is associated with one of the six instruction caches. Each of the plurality of program threads is associated with one of the six register files. Further, each of the six program threads includes a plurality of instructions and each of the plurality of instructions is stored within one of the six instruction caches of the memory.

### BACKGROUND

I. Field

The present disclosure generally relates to digital signal processors. More particularly, the disclosure relates to digital signal processor register files.

II. Description of Related Art

Advances in technology have resulted in smaller and more powerful personal computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and IP telephones, can communicate voice and data packets over wireless networks. Further, many such wireless telephones include other types of devices that are incorporated therein. For example, a wireless telephone can also include a digital still camera, a digital video camera, a digital recorder, and an audio file player. Also, such wireless telephones can include a web interface that can be used to access the Internet. As such, these wireless telephones include significant computing capabilities.

Typically, as these devices become smaller and more powerful, they become increasingly resource constrained. For example, the screen size, the amount of available memory and file system space, and the amount of input and output capabilities may be limited by the small size of the device. Further, the battery size, the amount of power provided by the battery, and the life of the battery is also limited. One way to increase the battery life of the device is to reduce the amount of time that a digital signal processor within the device is idle while the device is powered on.

Certain types of processors for these devices can utilize predicate values for determining when to access a register file. For example, in a sample processor, a program instruction, such as “add_eq R₁, R₂, R₃”, has “eq” as a predicate value. During execution of the “add_eq R₁, R₂, R₃” instruction, a second register and a third register are accessed and the values retrieved from the registers are added together. That sum can be written to the first register if the predicate value, “eq”, is true. However, if the predicate value is false, that sum is discarded. Unfortunately, the predicate value cannot be resolved before the second register and the third register are accessed. Moreover, each register file access consumes power and decreases the battery life of the processor. As such, if the predicate value is false after the register files have been accessed, two register file accesses are wasted.

Accordingly, it would be advantageous to provide an improved system and method of accessing register files within a digital signal processor for use in portable communication devices.

### SUMMARY

A processor device is disclosed and includes a memory unit and at least one interleaved multi-threading instruction pipeline. The interleaved multi-threading instruction pipeline utilizes a number of clock cycles that is less than an instruction issue rate for each of a plurality of program threads that are stored within the memory unit.

In a particular embodiment, the instruction pipeline utilizes six clock cycles and the instruction issue rate for each of the plurality of program threads is seven clock cycles. In another particular embodiment, the memory unit includes six instruction caches. Further, in yet another particular embodiment, the processor device includes six register files and each of the six register files is associated with one of the six instruction caches. Moreover, in a particular embodiment, each of the plurality of program threads is associated with one of the six register files. Each of the six program threads includes a plurality of instructions and each of the plurality of instructions is stored within one of the six instruction caches of the memory.

In still another particular embodiment, at least one of the plurality of program threads includes a first instruction that generates a predicate to be used by a second instruction of the same program thread. Moreover, the predicate is generated during the execution of the first instruction and prior to dispatching the second instruction for execution. In yet another particular embodiment, the memory unit includes an instruction queue having six instruction queues. Each instruction queue is associated with a single instruction cache within the memory and each instruction queue is coupled to a sequencer.

In another embodiment, a method of operating a digital signal processor is disclosed and includes decoding a first instruction of a first program thread. The first instruction generates a predicate for a second instruction of the first program thread. The method further includes executing the first instruction of the first program thread to resolve a value of the predicate and updating a first register associated with the first program thread to store the value of the predicate.

In yet another embodiment, a portable communication device is disclosed and includes a digital signal processor. The digital signal processor includes a memory unit, a sequencer that is responsive to the memory unit, at least one instruction execution unit that is responsive to the sequencer, and at least one interleaved multi-threading instruction pipeline. The interleaved multi-threading instruction pipeline has a number of stages that is less than or equal to a number of clock cycles between consecutive instruction issues for one of the plurality of program threads that are stored within the memory unit.

In still another embodiment, an audio file player is disclosed and includes a digital signal processor, an audio coder/decoder (CODEC) that is coupled to the digital signal processor, a multimedia card that is coupled to the digital signal processor, and a universal serial bus (USB) port that is coupled to the digital signal processor. The digital signal processor includes a memory unit, a sequencer that is responsive to the memory unit, at least one instruction execution unit that is responsive to the sequencer, and at least one interleaved multi-threading instruction pipeline. The interleaved multi-threading instruction pipeline utilizes a number of clock cycles that is less than an instruction issue rate for each of a plurality of program threads that are stored within the memory unit and that are to be executed using the interleaved multi-threading instruction pipeline.

In yet still another embodiment, a processor device is disclosed and includes means for decoding a first instruction of a first program thread. The first instruction generates a predicate for a second instruction of the first program thread. The processor device further includes means for executing the first instruction of the first program thread to resolve a value of the predicate and means for updating a first register that is associated with the first program thread to include the value of the predicate before issuing the second instruction of the first program thread for execution.

An advantage of one or more of the embodiments disclosed herein can include substantially preventing a digital signal processor from needlessly accessing one or more register files.

Another advantage can include providing an instruction pipeline that is shorter than the instruction issue rate of a program thread.

Still another advantage can include resolving a predicate before accessing one or more registers.

Yet another advantage can include substantially reducing power losses due to needlessly accessing one or more register files.

Other aspects, advantages, and features of the present disclosure will become apparent after review of the entire application, including the following sections: Brief Description of the Drawings, Detailed Description, and the Claims.

### BRIEF DESCRIPTION OF THE DRAWINGS

The aspects and the attendant advantages of the embodiments described herein will become more readily apparent by reference to the following detailed description when taken in conjunction with the accompanying drawings wherein:

FIG. 1 is a general diagram of an exemplary digital signal processor;

FIG. 2 is a general diagram of an exemplary unified register file of the digital signal processor shown in FIG. 1;

FIG. 3 is a diagram illustrating a multithreading operation of the digital signal processor shown in FIG. 1;

FIG. 4 is a diagram illustrating a detailed interleaved multithreading operation of the digital signal processor shown in FIG. 1;

FIG. 5 is a general diagram of a portable communication device incorporating a digital signal processor;

FIG. 6 is a general diagram of an exemplary cellular telephone incorporating a digital signal processor;

FIG. 7 is a general diagram of an exemplary wireless Internet Protocol telephone incorporating a digital signal processor;

FIG. 8 is a general diagram of an exemplary portable digital assistant incorporating a digital signal processor; and

FIG. 9 is a general diagram of an exemplary audio file player incorporating a digital signal processor.

### DETAILED DESCRIPTION

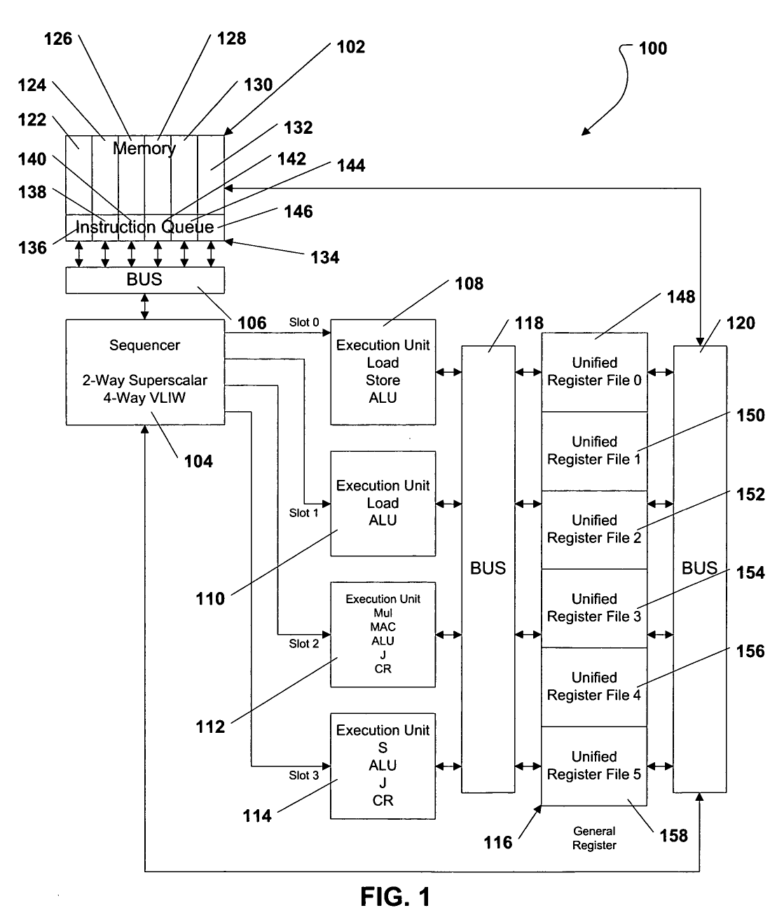

FIG. 1 illustrates a block diagram of an exemplary, non-limiting embodiment of a digital signal processor (DSP) 100. As illustrated in FIG. 1, the DSP 100 includes a memory 102 that is coupled to a sequencer 104 via a bus 106. In a particular embodiment, the bus 106 is a sixty-four (64) bit bus and the sequencer 104 is configured to retrieve instructions from the memory 102 having a length of thirty-two (32) bits. The bus 106 is coupled to a first instruction execution unit 108, a second instruction execution unit 110, a third instruction execution unit 112, and a fourth instruction execution unit 114. FIG. 1 indicates that each instruction execution unit 108, 110, 112, 114 can be coupled to a general register file 116 via a first bus 118. The general register file 116 can also be coupled to the sequencer 104 and the memory 102 via a second bus 120.

In a particular embodiment, the memory 102 includes a first instruction cache 122, a second instruction cache 124, a third instruction cache 126, a fourth instruction cache 128, a fifth instruction cache 130, and a sixth instruction cache 132. During operation, the instruction caches 122, 124, 126, 128, 130, 132 can be accessed independently of each other by the sequencer 104. Additionally, in a particular embodiment, each instruction cache 122, 124, 126, 128, 130, 132 includes a plurality of instructions, instruction steering data for each instruction, and instruction pre-decode data for each instruction.

As illustrated in FIG. 1, the memory 102 can include an instruction queue 134 that includes an instruction queue for each instruction cache 122, 124, 126, 128, 130, 132. In particular, the instruction queue 134 includes a first instruction queue 136 that is associated with the first instruction cache 122, a second instruction queue 138 that is associated with the second instruction cache 124, a third instruction queue 140 that is associated with the third instruction cache 126, a fourth instruction queue 142 that is associated with the fourth instruction cache 128, a fifth instruction queue 144 that is associated with the fifth instruction cache 130, and a sixth instruction queue 146 that is associated with the sixth instruction cache 132.

During operation, the sequencer 104 can fetch instructions from each instruction cache 122, 124, 126, 128, 130, 132 via the instruction queue 134. In a particular embodiment, the sequencer 104 fetches instructions from the instruction queues 136, 138, 140, 142, 144, 146 in order from the first instruction queue 136 to the sixth instruction queue 146. After fetching an instruction from the sixth instruction queue 146, the sequencer 104 returns to the first instruction queue 136 and continues fetching instructions from the instruction queues 136, 138, 140, 142, 144, 146 in order.

In a particular embodiment, the sequencer 104 operates in a first mode as a 2-way superscalar sequencer that supports superscalar instructions. Further, in a particular embodiment, the sequencer also operates in a second mode that supports very long instruction word (VLIW) instructions. In particular, the sequencer can operate as a 4-way VLIW sequencer. In a particular embodiment, the first instruction execution unit 108 can execute a load instruction, a store instruction, and an arithmetic logic unit (ALU) instruction. The second instruction execution unit 110 can execute a load instruction and an ALU instruction. Also, the third instruction execution unit can execute a multiply instruction, a multiply-accumulate instruction (MAC), an ALU instruction, a program redirect construct, and a transfer register (CR) instruction. FIG. 1 further indicates that the fourth instruction execution unit 114 can execute a shift (S) instruction, an ALU instruction, a program redirect construct, and a CR instruction. In a particular embodiment, the program redirect construct can be a zero overhead loop, a branch instruction, a jump (J) instruction, etc.

As depicted in FIG. 1, the general register 116 includes a first unified register file 148, a second unified register file 150, a third unified register file 152, a fourth unified register file 154, a fifth unified register file 156, and a sixth unified register file 158. Each unified register file 148, 150, 152, 154, 156, 158 corresponds to an instruction cache 122, 124, 126, 128, 130, 132 within the memory 102. Further, in a particular embodiment, each unified register file 148, 150, 152, 154, 156, 158 has the same construction and includes a number of data operands and a number of address operands.

During operation of the digital signal processor 100, instructions are fetched from the memory 102 by the sequencer 104, sent to designated instruction execution units 108, 110, 112, 114, and executed at the instruction execution unit 108, 110, 112, 114. Further, one or more operands are retrieved from the general register 116, e.g., one of the unified register files 148, 150, 152, 154, 156, 158 and used during the execution of the instructions. The results at each instruction execution unit 108, 110, 112, 114 can be written to the general register 116, i.e., to one of the unified register files 148, 150, 152, 154, 156, 158.

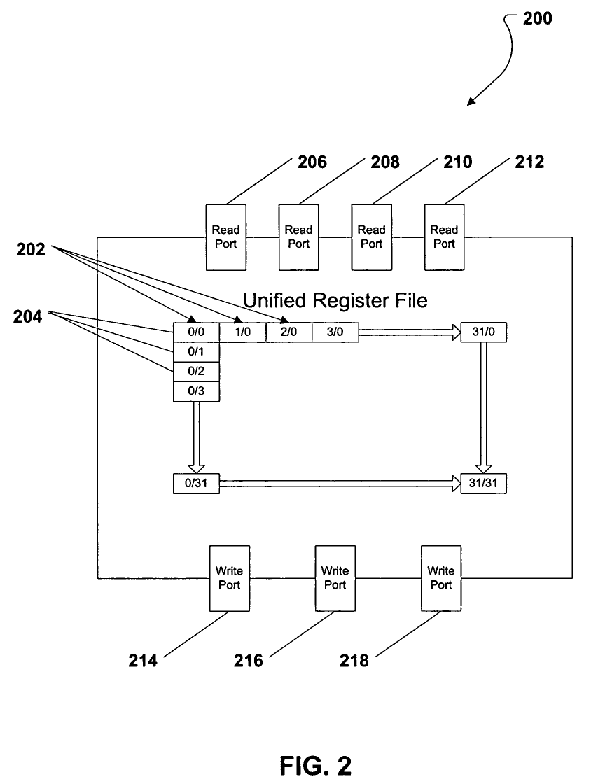

Referring to FIG. 2, an exemplary, non-limiting embodiment of a unified register file is shown and is generally designated 200. As shown, the unified register file 200 includes thirty-two (32) registers 202 and each register includes thirty-two (32) bits 204. FIG. 2 indicates that the unified register file 200 can include a first data read port 206, a second data read port 208, a third data read port 210, and a fourth data read port 212. Further, the unified register file 200 includes a first data write port 214, a second data write port 216, and a third data write port 218.

In a particular embodiment, one or more instructions can be associated with the unified register file 200. Further, during the execution of each instruction, the unified register file 200 associated with each instruction can be accessed via the four data read ports 206, 208, 210, 212 and the three data write ports 214, 216, 218. However, due to the interleaved multithreading method described below, more than four operands for the instruction can be retrieved from the unified register file 200 via the four data read ports 206, 208, 210, 212.

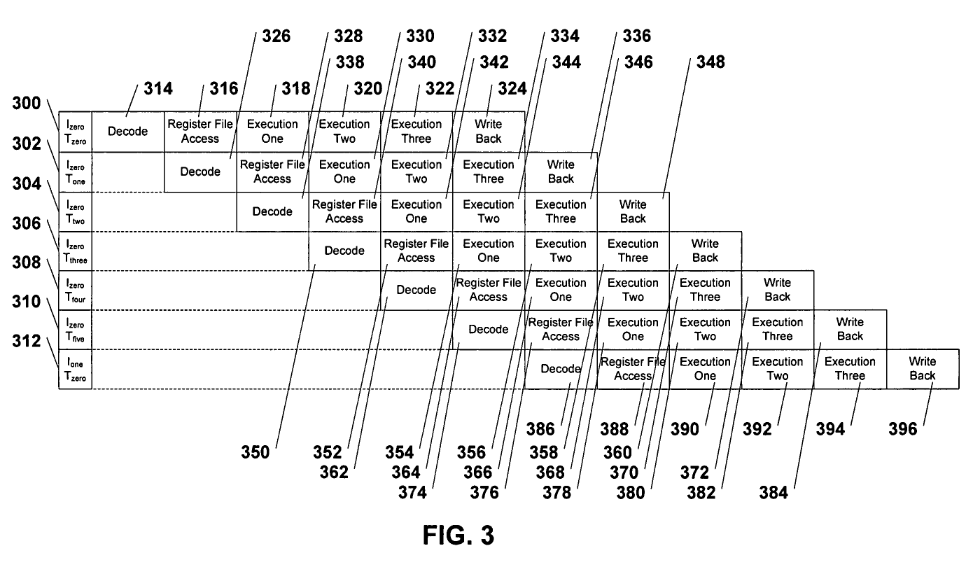

Referring to FIG. 3, a general method of multithreaded operation for a digital signal processor is shown. FIG. 3 shows the method as it is performed for the first instruction of six independent program threads and the second instruction of the first program thread. In particular, FIG. 3 depicts a first instruction of a first program thread 300, a first instruction of a second program thread 302, a first instruction of a third program thread 304, a first instruction of a fourth program thread 306, a first instruction of a fifth program thread 308, a first instruction of a sixth program thread 310, and a second instruction of the first program thread 312.

As depicted in FIG. 3, the first instruction of the first program thread 300 includes a decode step 314, a register file access step 316, a first execution step 318, a second execution step 320, a third execution step 322, and a writeback step 324 for the first instruction of the first program thread 300. The first instruction of the second program thread 302 includes a decode step 326, a register file access step 328, a first execution step 330, a second execution step 332, a third execution step 334, and a writeback step 336. Further, the first instruction of the third program thread 304 includes a decode step 338, a register file access step 340, a first execution step 342, a second execution step 344, a third execution step 346, and a writeback step 348.

In a particular embodiment, the first instruction of the fourth program thread 306 also includes a decode step 350, a register file access step 352, a first execution step 354, a second execution step 356, a third execution step 358, and a writeback step 360. Additionally, as shown in FIG. 3, the first instruction of the fifth program thread 308 includes a decode step 362, a register file access step 364, a first execution step 366, a second execution step 368, a third execution step 370, and a writeback step 372. Moreover, the first instruction of the sixth program thread 310 includes a decode step 374, a register file access step 376, a first execution step 378, a second execution step 380, a third execution step 382, and a writeback step 384. Finally, as depicted in FIG. 3, the second instruction of the first thread 312 includes a decode step 386, a register file access step 388, a first execution step 390, a second execution step 392, a third execution step 394, and a writeback step 396.

In a particular embodiment, as indicated in FIG. 3, the decode step 326 of the first instruction of the second program thread 302 is performed concurrently with the register file access step 316 of the first instruction of the first program thread 300. The decode step 338 of the first instruction of the third program thread 304 is performed concurrently with the register file access step 328 of the first instruction of the second program thread 302 and the first execution step 318 of the first instruction of the first program thread 300. Further, the decode step 350 of the first instruction of the fourth program thread 306 is performed concurrently with the register file access step 340 of the first instruction of the third program thread 304, the first execution step 330 of the first instruction of the second program thread 302, and the second execution step 320 of the first instruction of the first program thread 300.

FIG. 3 further shows that the decode step 362 of the first instruction of the fifth program thread 308 is performed concurrently with the register file access step 352 of the first instruction of the fourth program thread 306, the first execution step 342 of the first instruction of the third program thread 304, the second execution step 332 of the first instruction of the second program thread 302, and the third execution step 322 of the first instruction of the first program thread 300. Additionally, the decode step 374 of the first instruction of the sixth program thread 310 is performed concurrently with the register file access step 364 of the first instruction of the fifth program thread 308, the first execution step 354 of the first instruction of the fourth program thread 306, the second execution step 344 of the first instruction of the third program thread 304, the third execution step 334 of the first instruction of the second program thread 302, and the writeback step 324 of the first instruction of the first program thread 300.

As indicated in FIG. 3, the decode step 386 of the first thread of the second instruction 312 is performed concurrently with the register file access step 376 of the sixth thread of the first instruction 310, the first execution step 366 of the first instruction of the fifth program thread 308, the second execution step 356 of the first instruction of the fourth program thread 306, the third execution step 346 of the first instruction of the third program thread 304, and the writeback step 336 of the first instruction of the second program thread 302.

In a particular embodiment, the decode step, the register file access step, the first execution step, the second execution step, the third execution step, and the write back step for each of the instructions of the program threads establish instruction pipelines for the program threads. Each pipeline utilizes a number of clock cycles, e.g., six clock cycles, that is less than an instruction issue rate, seven clock cycles, for each program thread stored within the memory unit. For example, a new instruction for the first program thread can issue after an instruction is issued for sixth program thread.

In alternative embodiments, the pipelines can utilize other numbers of clock cycles, e.g., 4, 5, 7, 8, etc., and the instruction issue rate can be one or more clock cycles greater than the clock cycles utilized by each pipeline. In other words, a succeeding instruction for a particular program thread is not issued until a previous instruction that generates a predicate is resolved.

As such, in a particular embodiment, a predicate value for the second instruction of the first program thread 312 can be generated during the first instruction of the first program thread 300, e.g., during the first execution step 318, the second execution step 320, or the third execution step of the first instruction of the first program thread 300. The value of the predicate is updated to the register file during the writeback step 324 of the first instruction of the first program thread prior to the decode step 386 of the second instruction of the first program thread 312. During execution of the second instruction of the first program thread 312, if the predicate value is true, any register file accesses within the second instruction of the first program thread 312 that depend on the predicate value will be performed. Otherwise, if the predicate value is false, then a no operation (NOP) is performed in lieu of a register access. As such, power is not wasted by needlessly accessing register files due to predicate conditions.

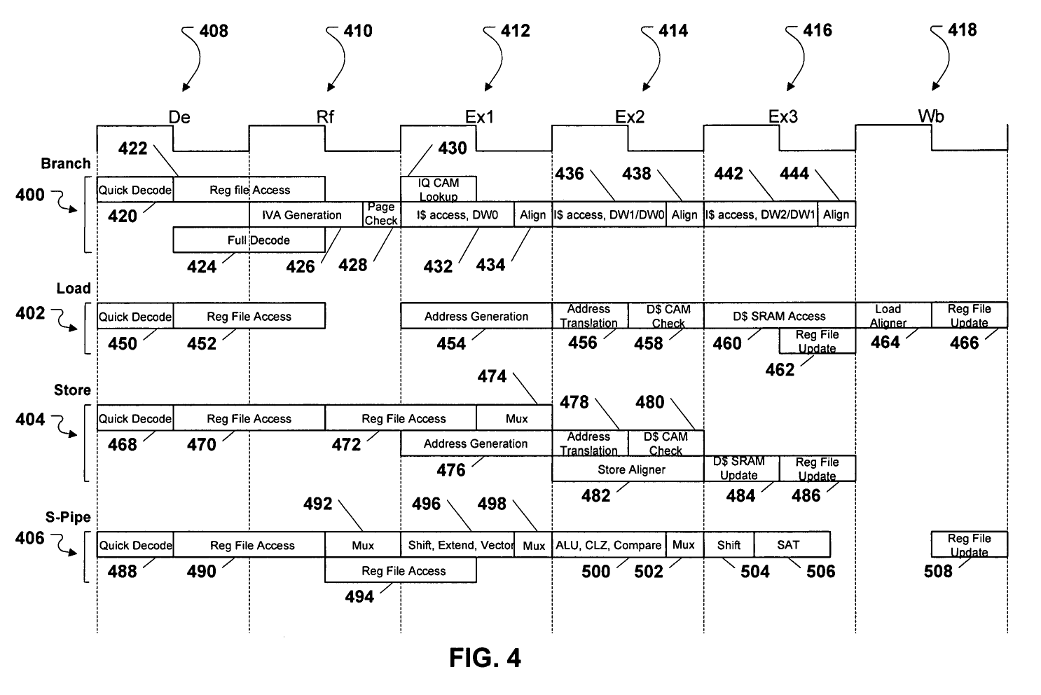

Referring now to FIG. 4, a detailed method of interleaved multithreading for a digital signal processor is shown. FIG. 4 shows that the method includes a branch routine 400, a load routine 402, a store routine 404, and an s-pipe routine 406. Each routine 400, 402, 404, 406 includes a plurality of steps that are performed during six clock cycles for each instruction fetched from an instruction queue by a sequencer. In a particular embodiment, the clock cycles include a decode clock cycle 408, a register file access clock cycle 410, a first execution clock cycle 412, a second execution clock cycle 414, a third execution clock cycle 416, and a writeback clock cycle 418. Further, each clock cycle includes a first portion and a second portion.

FIG. 4 shows that during the branch routine 400, at block 420, a quick decode for the instruction is performed within a sequencer during a first portion of the decode clock cycle. At block 422, during the second portion of the decode clock cycle 408, the sequencer accesses a register file, e.g., starts a register file access for a first operand. The register access of block 422 finishes within the register file access clock cycle 410 and the first operand is retrieved from the register file. In a particular embodiment, the sequencer accesses the register file via a first data read port. As shown, the register file access of block 422 occurs during the second portion of the decode clock cycle 408 and the first portion of the register file access clock cycle 410. As such, the register file access overlaps the decode clock cycle 408 and the register file access clock cycle 410.

At block 424, also during the decode clock cycle 408, the sequencer begins a full decode for the instruction. The full decode performed by the sequencer occurs within the second portion of the decode clock cycle 408 and the first portion of the register file access clock cycle 410.

During the register file access clock cycle 410, at block 426, the sequencer generates an instruction virtual address (IVA). Thereafter, at block 428, the sequencer performs a page check in order to determine the physical address page associated with a virtual address page number. Moving to the first execution clock cycle 412, at block 430, the sequencer performs an instruction queue lookup. At block 432, the sequencer accesses an instruction cache a first time and retrieves a first double-word for the instruction. In a particular embodiment, each instruction includes three double-words, e.g., a first double-word, a second double-word, and a third double-word. At block 434, during the first execution clock cycle 412, the sequencer aligns the double-word coming from the instruction cache.

Continuing to the second execution clock cycle 414, the sequencer accesses the instruction cache a second time in order to retrieve the second double-word for the instruction at block 436. Next, at block 438, the sequencer aligns the double-word retrieved from the instruction cache.

Proceeding to the third execution clock cycle 416, the sequencer accesses the instruction cache a third time in order to retrieve a third double-word at block 442. After the sequencer accesses the instruction cache the third time, the sequencer aligns the third double-word, at block 444.

As illustrated in FIG. 4, during the load routine 402, at block 450, the sequencer performs a quick decode for the instruction during the first portion of the decode clock cycle 408. At block 452, during the second portion of the decode clock cycle 408, the sequencer begins a register file access. As shown, the second register access by the sequencer spans two clock cycles, i.e., including the second portion of the decode clock cycle 408 and the first portion of register file access clock cycle 410. As such, the register file access ends within the register file access clock cycle 410 and a second operand can be retrieved. Next, during the first execution cycle 412, at block 454, an address generation unit within a first instruction execution unit generates a first virtual address for the instruction based on the previously read register file content.

At block 456, during the second execution clock cycle 414, a data translation look-aside buffer (DTLB) performs an address translation for the first virtual address in order to generate a first physical address. Still within the second execution clock cycle 414, at block 458, the sequencer performs a tag check.

Moving to the third execution cycle 416, the sequencer accesses a data cache static random access memory (SRAM) in order to read data out of the SRAM, at block 460. Also, within the third execution cycle, at block 462, the sequencer updates the register file associated with the instruction a first time via a first data write port. In a particular embodiment, the sequencer updates the register file with the results of a post increment address. Next, during the writeback clock cycle 418, at block 464 a load aligner shifts data to align the data within the double-word. At block 466, also within the writeback clock cycle 418, the sequencer updates the register file for the instruction a second time via the first data write port with data loaded from the cache.

FIG. 4 shows that during the store routine 404, at block 468, the sequencer performs a quick decode for the instruction during the decode clock cycle 408. Further, during the decode clock cycle 408, at block 470, the sequencer accesses a register file associated with the instruction a third time via a third data read port. The register access of block 470 occurs within the last portion of the decode clock cycle 408 and the first portion of the register file access clock cycle 410. As such, the register file begins within the decode clock cycle 408 and ends within the register file access clock cycle 410. In a particular embodiment, a third operand is retrieved from the register file during the register file access clock cycle 410.

As depicted in FIG. 4, during the second portion of the register file access clock cycle 410, the sequencer access the register file for the instruction a fourth time via the third data read port at block 472. The fourth register file commences within the register file access clock cycle 410 and ends within the first execution clock cycle 412 wherein a fourth operand is retrieved from the register. In a particular embodiment, the third data read port is used to access the register in order to retrieve the third operand and the fourth operand. At block 474, a portion of the data from the sequencer is multiplexed at a multiplexer. Also, during the first execution clock cycle 412, a second address generation unit within a second instruction execution unit generates a virtual address for the instruction based on the previously read data from the register file.

Proceeding to the second execution clock cycle 414, during the store routine, at block 478, the data translation look-aside buffer (DTLB) translates the previously generated virtual address for the instruction into a physical address. At block 480, within the second execution clock cycle 414, the sequencer performs a tag check. Also, during the second execution clock cycle 414, at block 482, a store aligner aligns a store data to the appropriate byte, half-word, or word boundary within a double-word before writing the data to the data cache. Moving to the third execution clock cycle 416, at block 484, the sequencer updates the data cache static random access memory. Then, at block 486, the sequencer updates the register file for the instruction a third time via a second data write port with the results of executing the instruction during the third execution clock cycle 416.

As illustrated in FIG. 4, the s-pipe routine 406 begins during the decode clock cycle 408, at block 488, where a quick decode is performed for the instruction. At block 490, the sequencer accesses the register file for the instruction a fifth time via a fourth data read port. The fifth register file access also spans two clock cycles and begins within the second portion of the decode clock cycle 408 and ends within the first portion of the register file access clock cycle 410 wherein a fifth operand is retrieved. Still during the register file access clock cycle 410, a portion of the data from the register file for the instruction is multiplexed at a multiplexer. Also, during the register file access clock cycle 410, the sequencer accesses the register file for the instruction a sixth time via the fourth data read port at block 494. The sixth access to the register file begins within the second portion of the register file access clock cycle 410 and ends within the first portion of the first execution clock cycle 412. A sixth operand is retrieved during the first execution clock cycle 412.

Proceeding to the second execution clock cycle 414, at block 496, data retrieved during the fifth register file access and the sixth register file access is sent to a 64-bit shifter, a vector unit, and a sign/zero extender. Also, during the first execution clock cycle, at block 498, the data from the shifter, the vector unit, and the sign/zero extender is multiplexed.

Moving to the second execution clock cycle 414, the multiplexed data from the shifter, the vector unit, and the sign/zero extender is sent to an arithmetic logic unit, a count leading zeros unit, or a comparator at block 500. At block 502, the data from the arithmetic logic unit, the count leading zeros unit, and the comparator is multiplexed at a single multiplexer. After the data is multiplexed, the shifter shifts the multiplexed data in order to multiply the data by 2, 4, 8, etc. at block 504 during the third execution clock cycle 416. Then, at block 506, the output of the shifter is saturated. During the writeback clock cycle 418, at block 508, the register file for the instruction is updated a fourth time via a third write data port.

In a particular embodiment, as illustrated in FIG. 4, the method of interleaved multithreading for the digital signal processor utilizes four read ports for each register and three write ports for each register. Due to recycling of read ports and write ports, six operands can be retrieved via the four read data ports. Further, four results can be updated to the register file via three write data ports.

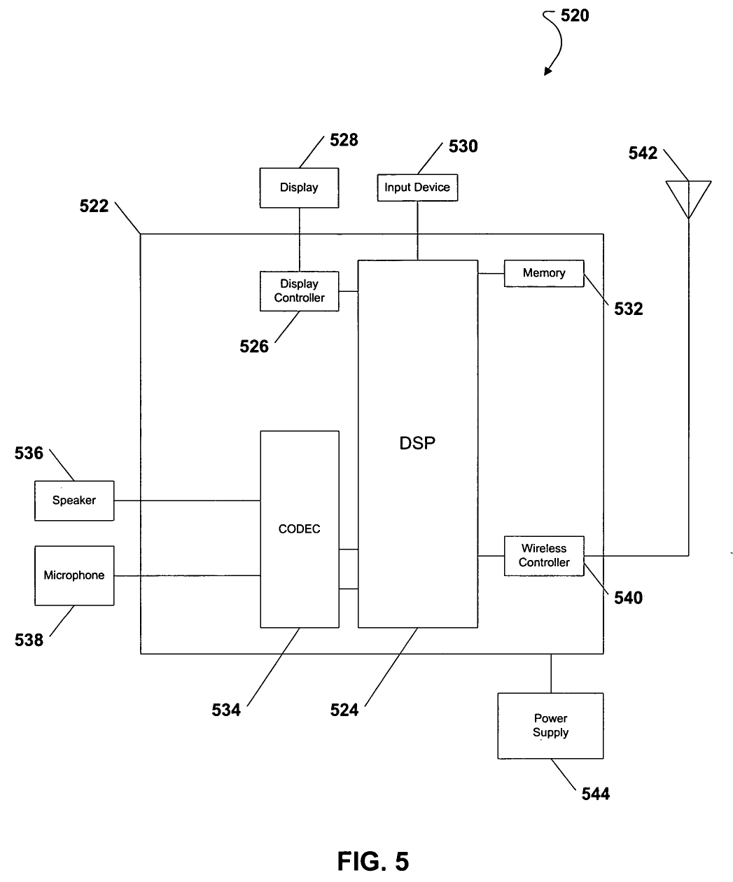

FIG. 5 illustrates an exemplary, non-limiting embodiment of a portable communication device that is generally designated 520. As illustrated in FIG. 5, the portable communication device includes an on-chip system 522 that includes a digital signal processor 524. In a particular embodiment, the digital signal processor 524 is the digital signal processor shown in FIG. 1 and described herein. FIG. 5 also shows a display controller 526 that is coupled to the digital signal processor 524 and a display 528. Moreover, an input device 530 is coupled to the digital signal processor 524. As shown, a memory 532 is coupled to the digital signal processor 524. Additionally, a coder/decoder (CODEC) 534 can be coupled to the digital signal processor 524. A speaker 536 and a microphone 538 can be coupled to the CODEC 530.

FIG. 5 also indicates that a wireless controller 540 can be coupled to the digital signal processor 524 and a wireless antenna 542. In a particular embodiment, a power supply 544 is coupled to the on-chip system 522. Moreover, in a particular embodiment, as illustrated in FIG. 5, the display 528, the input device 530, the speaker 536, the microphone 538, the wireless antenna 542, and the power supply 544 are external to the on-chip system 522. However, each is coupled to a component of the on-chip system 522.

In a particular embodiment, the digital signal processor 524 utilizes interleaved multithreading to process instructions associated with program threads necessary to perform the functionality and operations needed by the various components of the portable communication device 520. For example, when a wireless communication session is established via the wireless antenna a user can speak into the microphone 538. Electronic signals representing the user's voice can be sent to the CODEC 534 to be encoded. The digital signal processor 524 can perform data processing for the CODEC 534 to encode the electronic signals from the microphone. Further, incoming signals received via the wireless antenna 542 can be sent to the CODEC 534 by the wireless controller 540 to be decoded and sent to the speaker 536. The digital signal processor 524 can also perform the data processing for the CODEC 534 when decoding the signal received via the wireless antenna 542.

Further, before, during, or after the wireless communication session, the digital signal processor 524 can process inputs that are received from the input device 530. For example, during the wireless communication session, a user may be using the input device 530 and the display 528 to surf the Internet via a web browser that is embedded within the memory 532 of the portable communication device 520. The digital signal processor 524 can interleave various program threads that are used by the input device 530, the display controller 526, the display 528, the CODEC 534 and the wireless controller 540, as described herein, to efficiently control the operation of the portable communication device 520 and the various components therein. Many of the instructions associated with the various program threads are executed concurrently during one or more clock cycles. As such, the power and energy consumption due to wasted clock cycles is substantially decreased.

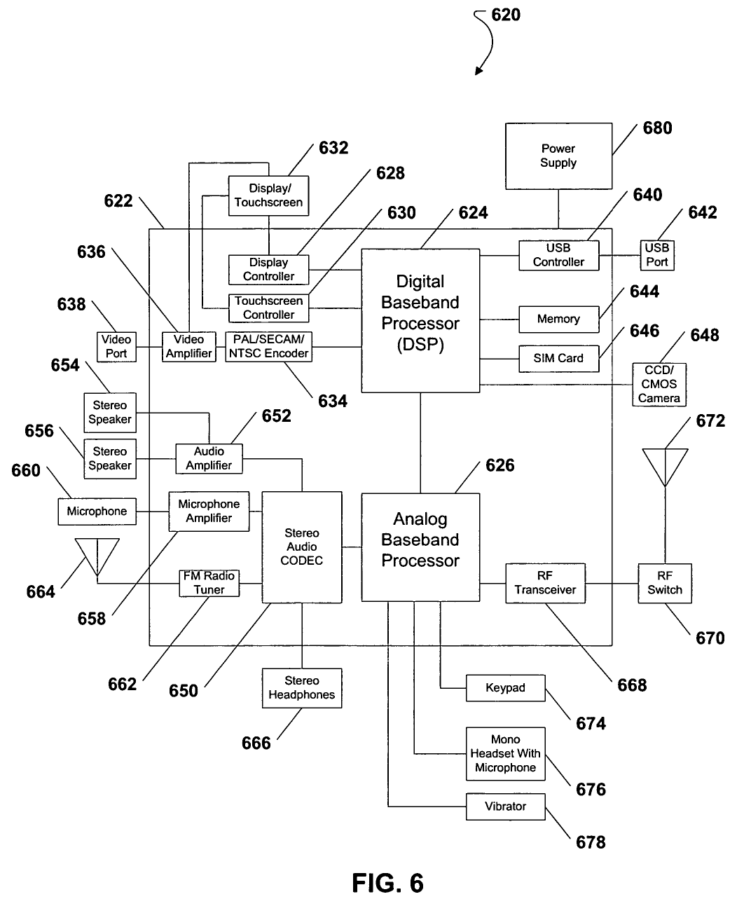

Referring to FIG. 6, an exemplary, non-limiting embodiment of a cellular telephone is shown and is generally designated 620. As shown, the cellular telephone 620 includes an on-chip system 622 that includes a digital baseband processor 624 and an analog baseband processor 626 that are coupled together. In a particular embodiment, the digital baseband processor 624 is a digital signal processor, e.g., the digital signal processor shown in FIG. 1 and described herein. Further, in a particular embodiment, the analog baseband processor 626 can also be a digital signal processor, e.g., the digital signal processor shown in FIG. 1. As illustrated in FIG. 6, a display controller 628 and a touchscreen controller 630 are coupled to the digital baseband processor 624. In turn, a touchscreen display 632 external to the on-chip system 622 is coupled to the display controller 628 and the touchscreen controller 630.

FIG. 6 further indicates that a video encoder 634, e.g., a phase alternating line (PAL) encoder, a sequential couleur a memoire (SECAM) encoder, or a national television system(s) committee (NTSC) encoder, is coupled to the digital baseband processor 624. Further, a video amplifier 636 is coupled to the video encoder 634 and the touchscreen display 632. Also, a video port 638 is coupled to the video amplifier 636. As depicted in FIG. 6, a universal serial bus (USB) controller 640 is coupled to the digital baseband processor 624. Also, a USB port 642 is coupled to the USB controller 640. A memory 644 and a subscriber identity module (SIM) card 646 can also be coupled to the digital baseband processor 624. Further, as shown in FIG. 6, a digital camera 648 can be coupled to the digital baseband processor 624. In an exemplary embodiment, the digital camera 648 is a charge-coupled device (CCD) camera or a complementary metal-oxide semiconductor (CMOS) camera.

As further illustrated in FIG. 6, a stereo audio CODEC 650 can be coupled to the analog baseband processor 626. Moreover, an audio amplifier 652 can coupled to the to the stereo audio CODEC 650. In an exemplary embodiment, a first stereo speaker 654 and a second stereo speaker 656 are coupled to the audio amplifier 652. FIG. 6 shows that a microphone amplifier 658 can be also coupled to the stereo audio CODEC 650. Additionally, a microphone 660 can be coupled to the microphone amplifier 658. In a particular embodiment, a frequency modulation (FM) radio tuner 662 can be coupled to the stereo audio CODEC 650. Also, an FM antenna 664 is coupled to the FM radio tuner 662. Further, stereo headphones 666 can be coupled to the stereo audio CODEC 650.

FIG. 6 further indicates that a radio frequency (RF) transceiver 668 can be coupled to the analog baseband processor 626. An RF switch 670 can be coupled to the RF transceiver 668 and an RF antenna 672. As shown in FIG. 6, a keypad 674 can be coupled to the analog baseband processor 626. Also, a mono headset with a microphone 676 can be coupled to the analog baseband processor 626. Further, a vibrator device 678 can be coupled to the analog baseband processor 626. FIG. 6 also shows that a power supply 680 can be coupled to the on-chip system 622. In a particular embodiment, the power supply 680 is a direct current (DC) power supply that provides power to the various components of the cellular telephone 620 that require power. Further, in a particular embodiment, the power supply is a rechargeable DC battery or a DC power supply that is derived from an alternating current (AC) to DC transformer that is connected to an AC power source.

In a particular embodiment, as depicted in FIG. 6, the touchscreen display 632, the video port 638, the USB port 642, the camera 648, the first stereo speaker 654, the second stereo speaker 656, the microphone 660, the FM antenna 664, the stereo headphones 666, the RF switch 670, the RF antenna 672, the keypad 674, the mono headset 676, the vibrator 678, and the power supply 680 are external to the on-chip system 622. Moreover, in a particular embodiment, the digital baseband processor 624 and the analog baseband processor 626 can use interleaved multithreading, described herein, in order to process the various program threads associated with one or more of the different components associated with the cellular telephone 620.

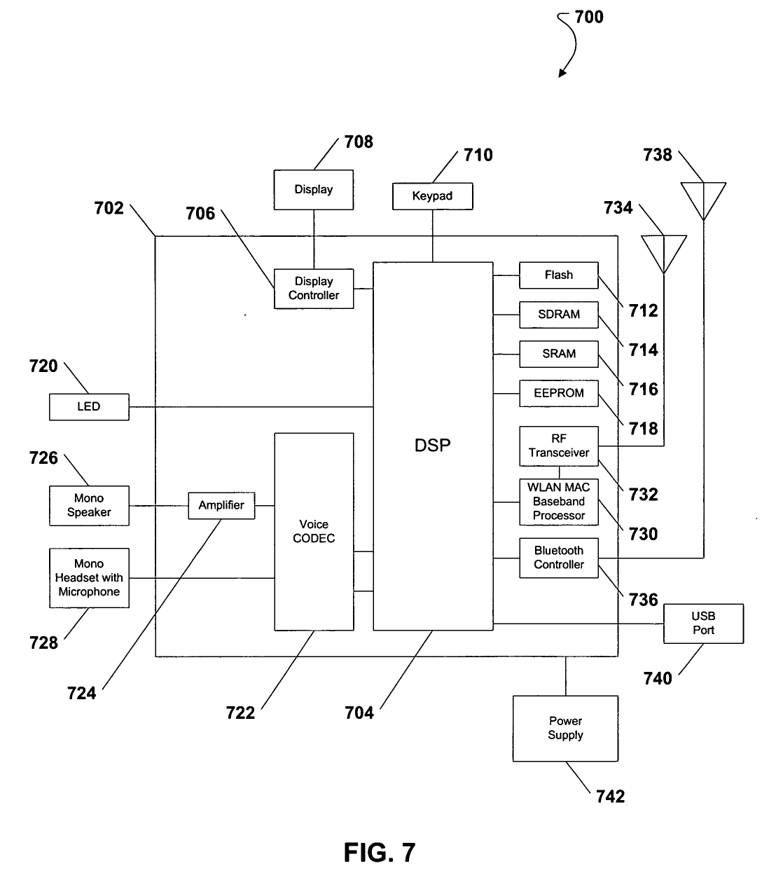

Referring to FIG. 7, an exemplary, non-limiting embodiment of a wireless Internet protocol (IP) telephone is shown and is generally designated 700. As shown, the wireless IP telephone 700 includes an on-chip system 702 that includes a digital signal processor (DSP) 704. In a particular embodiment, the DSP 704 is the digital signal processor shown in FIG. 1 and described herein. As illustrated in FIG. 7, a display controller 706 is coupled to the DSP 704 and a display 708 is coupled to the display controller 706. In an exemplary embodiment, the display 708 is a liquid crystal display (LCD). FIG. 7 further shows that a keypad 710 can be coupled to the DSP 704.

As further depicted in FIG. 7, a flash memory 712 can be coupled to the DSP 704. A synchronous dynamic random access memory (SDRAM) 714, a static random access memory (SRAM) 716, and an electrically erasable programmable read only memory (EEPROM) 718 can also be coupled to the DSP 704. FIG. 7 also shows that a light emitting diode (LED) 720 can be coupled to the DSP 704. Additionally, in a particular embodiment, a voice CODEC 722 can be coupled to the DSP 704. An amplifier 724 can be coupled to the voice CODEC 722 and a mono speaker 726 can be coupled to the amplifier 724. FIG. 7 further indicates that a mono headset 728 can also be coupled to the voice CODEC 722. In a particular embodiment, the mono headset 728 includes a microphone.

FIG. 7 also illustrates that a wireless local area network (WLAN) baseband processor 730 can be coupled to the DSP 704. An RF transceiver 732 can be coupled to the WLAN baseband processor 730 and an RF antenna 734 can be coupled to the RF transceiver 732. In a particular embodiment, a Bluetooth controller 736 can also be coupled to the DSP 704 and a Bluetooth antenna 738 can be coupled to the controller 736. FIG. 7 also shows that a USB port 740 can also be coupled to the DSP 704. Moreover, a power supply 742 is coupled to the on-chip system 702 and provides power to the various components of the wireless IP telephone 700 via the on-chip system 702.

In a particular embodiment, as indicated in FIG. 7, the display 708, the keypad 710, the LED 720, the mono speaker 726, the mono headset 728, the RF antenna 734, the Bluetooth antenna 738, the USB port 740, and the power supply 742 are external to the on-chip system 702. However, each of these components is coupled to one or more components of the on-chip system. Further, in a particular embodiment, the digital signal processor 704 can use interleaved multithreading, as described herein, in order to process the various program threads associated with one or more of the different components associated with the IP telephone 700.

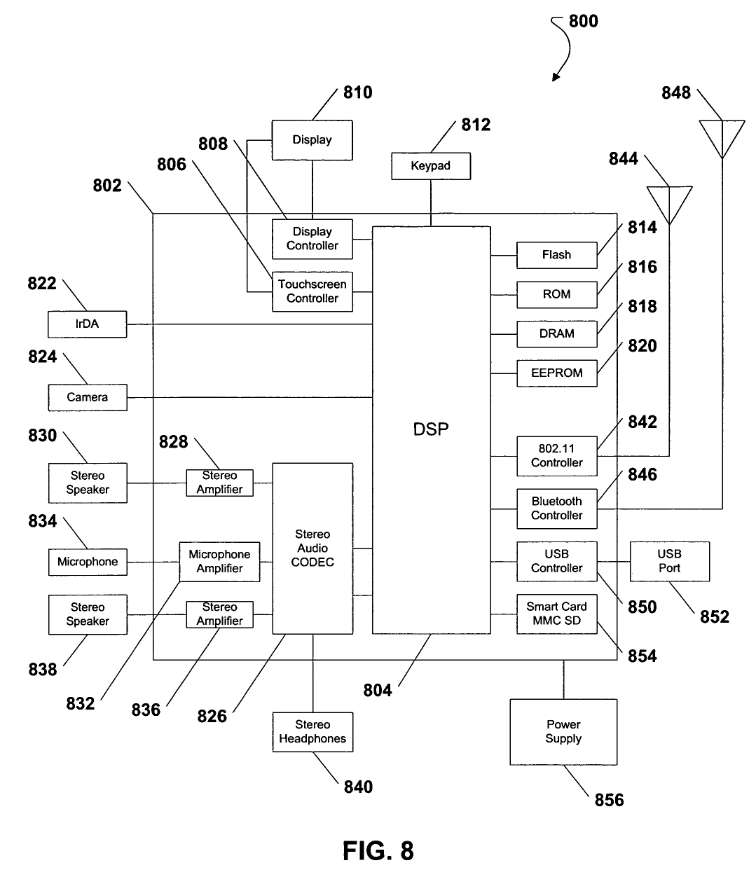

FIG. 8 illustrates an exemplary, non-limiting embodiment of a portable digital assistant (PDA) that is generally designated 800. As shown, the PDA 800 includes an on-chip system 802 that includes a digital signal processor (DSP) 804. In a particular embodiment, the DSP 804 is the digital signal processor shown in FIG. 1 and described herein. As depicted in FIG. 8, a touchscreen controller 806 and a display controller 808 are coupled to the DSP 804. Further, a touchscreen display is coupled to the touchscreen controller 806 and to the display controller 808. FIG. 8 also indicates that a keypad 812 can be coupled to the DSP 804.

As further depicted in FIG. 8, a flash memory 814 can be coupled to the DSP 804. Also, a read only memory (ROM) 816, a dynamic random access memory (DRAM) 818, and an electrically erasable programmable read only memory (EEPROM) 820 can be coupled to the DSP 804. FIG. 8 also shows that an infrared data association (IrDA) port 822 can be coupled to the DSP 804. Additionally, in a particular embodiment, a digital camera 824 can be coupled to the DSP 804.

As shown in FIG. 8, in a particular embodiment, a stereo audio CODEC 826 can be coupled to the DSP 804. A first stereo amplifier 828 can be coupled to the stereo audio CODEC 826 and a first stereo speaker 830 can be coupled to the first stereo amplifier 828. Additionally, a microphone amplifier 832 can be coupled to the stereo audio CODEC 826 and a microphone 834 can be coupled to the microphone amplifier 832. FIG. 8 further shows that a second stereo amplifier 836 can be coupled to the stereo audio CODEC 826 and a second stereo speaker 838 can be coupled to the second stereo amplifier 836. In a particular embodiment, stereo headphones 840 can also be coupled to the stereo audio CODEC 826.

FIG. 8 also illustrates that an 802.11 controller 842 can be coupled to the DSP 804 and an 802.11 antenna 844 can be coupled to the 802.11 controller 842. Moreover, a Bluetooth controller 846 can be coupled to the DSP 804 and a Bluetooth antenna 848 can be coupled to the Bluetooth controller 846. As depicted in FIG. 8, a USB controller 850 can be coupled to the DSP 804 and a USB port 852 can be coupled to the USB controller 850. Additionally, a smart card 854, e.g., a multimedia card (MMC) or a secure digital card (SD) can be coupled to the DSP 804. Further, as shown in FIG. 8, a power supply 856 can be coupled to the on-chip system 802 and can provide power to the various components of the PDA 800 via the on-chip system 802.

In a particular embodiment, as indicated in FIG. 8, the display 810, the keypad 812, the IrDA port 822, the digital camera 824, the first stereo speaker 830, the microphone 834, the second stereo speaker 838, the stereo headphones 840, the 802.11 antenna 844, the Bluetooth antenna 848, the USB port 852, and the power supply 850 are external to the on-chip system 802. However, each of these components is coupled to one or more components on the on-chip system. Additionally, in a particular embodiment, the digital signal processor 804 can use interleaved multithreading, described herein, in order to process the various program threads associated with one or more of the different components associated with the portable digital assistant 800.

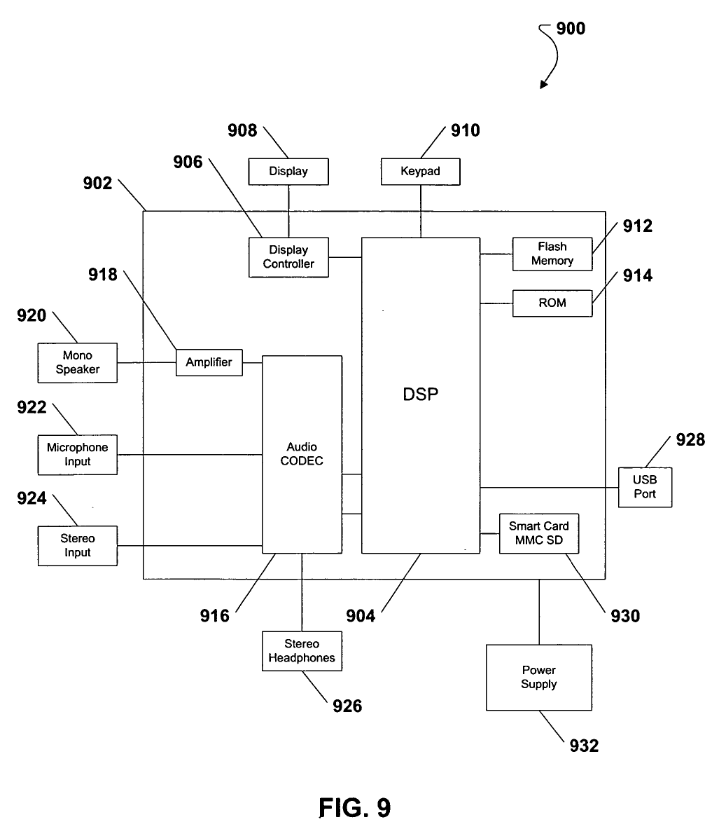

Referring to FIG. 9, an exemplary, non-limiting embodiment of an audio file player, such as moving pictures experts group audio layer-3 (MP3) player is shown and is generally designated 900. As shown, the audio file player 900 includes an on-chip system 902 that includes a digital signal processor (DSP) 904. In a particular embodiment, the DSP 904 is the digital signal processor shown in FIG. 1 and described herein. As illustrated in FIG. 9, a display controller 906 is coupled to the DSP 904 and a display 908 is coupled to the display controller 906. In an exemplary embodiment, the display 908 is a liquid crystal display (LCD). FIG. 9 further shows that a keypad 910 can be coupled to the DSP 904.

As further depicted in FIG. 9, a flash memory 912 and a read only memory (ROM) 914 can be coupled to the DSP 904. Additionally, in a particular embodiment, an audio CODEC 916 can be coupled to the DSP 904. An amplifier 918 can be coupled to the audio CODEC 916 and a mono speaker 920 can be coupled to the amplifier 918. FIG. 9 further indicates that a microphone input 922 and a stereo input 924 can also be coupled to the audio CODEC 916. In a particular embodiment, stereo headphones 926 can also be coupled to the audio CODEC 916.

FIG. 9 also indicates that a USB port 928 and a smart card 930 can be coupled to the DSP 904. Additionally, a power supply 932 can be coupled to the on-chip system 902 and can provide power to the various components of the audio file player 900 via the on-chip system 902.

In a particular embodiment, as indicated in FIG. 9, the display 908, the keypad 910, the mono speaker 920, the microphone input 922, the stereo input 924, the stereo headphones 926, the USB port 928, and the power supply 932 are external to the on-chip system 902. However, each of these components is coupled to one or more components on the on-chip system. Also, in a particular embodiment, the digital signal processor 904 can use interleaved multithreading, described herein, in order to process the various program threads associated with one or more of the different components associated with the audio file player 900.

With the configuration of structure disclosed herein, the system and method of using a predicate value to access a register file provides a way to prevent a digital signal processor from needlessly accessing one or more register files to execute a conditional instruction that may or may not update a register with results of the execution of the conditional instruction based on the value of a subsequently determined predicate. Further, the system and method described herein provides an instruction pipeline that is shorter than the instruction access rate of a program thread. As such, the predicate can be resolved before any registers are accessed based on the predicate. Accordingly, power that is no longer wasted by needlessly accessing register files and discarding the results of a conditional instruction.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in RAM memory, flash memory, ROM memory, PROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a computing device or a user terminal. In the alternative, the processor and the storage medium may reside as discrete components in a computing device or user terminal.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features as defined by the following claims.

What is claimed is:

1. A processor device comprising:
a memory unit; and
at least one interleaved multi-threading instruction pipeline, wherein the interleaved multi-threading instruction pipeline utilizes a number of clock cycles that is less than an instruction issue rate for each of a plurality of program threads that are stored within the memory unit.

2. The processor device of claim 1, wherein the instruction pipeline utilizes six clock cycles and the instruction issue rate for each of the plurality of program threads is seven clock cycles.

3. The processor device of claim 1, wherein the memory unit includes six instruction caches.

4. The processor device of claim 3, further comprising six register files, wherein each of the six register files is associated with one of the six instruction caches.

5. The processor device of claim 4, wherein each of the plurality of program threads is associated with one of the six register files.

6. The processor device of claim 5, wherein each of the six program threads includes a plurality of instructions.

7. The processor device of claim 6, wherein each of the plurality of instructions of each of the plurality of program threads is stored within one of the six instruction caches of the memory.

8. The processor device of claim 1, wherein at least one of the plurality of program threads includes a first instruction that generates a predicate to be used by a second instruction of the at least one program thread.

9. The processor device of claim 8, wherein the predicate is resolved during the execution of the first instruction and prior to dispatching the second instruction for execution.

10. The processor device of claim 9, wherein the memory unit includes an instruction queue having six instruction queues, wherein each instruction queue is associated with a single instruction cache within the memory.

11. The processor device of claim 10, wherein each instruction queue is coupled to a sequencer.

12. A method of operating a digital signal processor, the method comprising:
decoding a first instruction of a first program thread, wherein the first instruction generates a predicate for a succeeding instruction of the first program thread;
executing the first instruction of the first program thread to generate a value of the predicate; and
updating a predicate register associated with the first program thread to store the value of the predicate.

13. The method of claim 12, further comprising:
executing a first instruction of a second program thread;
executing a first instruction of a third program thread;
executing a first instruction of a fourth program thread;
executing a first instruction of a fifth program thread; and
executing a first instruction of a sixth program thread.

14. The method of claim 13, further comprising accessing the predicate register during execution of a second instruction of the first program thread.

15. The method of claim 14, further comprising retrieving the value of the predicate from the predicate register.

16. The method of claim 15, further comprising accessing one or more register files if the value of the predicate is true.

17. The method of claim 16, further comprising performing no operation if the value of the predicate is false.

18. A portable communication device, comprising:
a digital signal processor;
wherein the digital signal processor includes:
a memory unit;
a sequencer responsive to the memory unit;
at least one instruction execution unit responsive to the sequencer; and
at least one interleaved multi-threading instruction pipeline, wherein the interleaved multi-threading instruction pipeline has a number of stages that is less than or equal to a number of clock cycles between consecutive instruction issues for one of the plurality of program threads that are stored within the memory unit.

19. The portable communication device of claim 18, wherein the instruction pipeline utilizes six stages and the instruction issue rate for each of the plurality of program threads is seven clock cycles.

20. The portable communication device of claim 18, wherein the sequencer supports very long instruction word (VLIW) type instructions in a first mode of operation.

21. The portable communication device of claim 20, wherein the sequencer supports superscalar type instructions in a second mode of operation.

22. The portable communication device of claim 18, wherein the digital signal processor comprises six interleaved multi-threading instruction pipelines.

23. The portable communication device of claim 22, wherein the memory unit includes six instruction caches and each instruction cache is associated with one of the six interleaved multi-threading instruction pipelines.

24. The portable communication device of claim 23, wherein the memory unit includes an instruction queue having six instruction queues, wherein each instruction queue is associated with a single instruction cache within the memory.

25. The portable communication device of claim 18, further comprising:
an analog baseband processor coupled to the digital signal processor;
a stereo audio coder/decoder (CODEC) coupled to the analog baseband processor;
a radio frequency (RF) transceiver coupled to the analog baseband processor;
an RF switch coupled to the RF transceiver; and
an RF antenna coupled to the RF switch.

26. The portable communication device of claim 18, further comprising:
a voice coder/decoder (CODEC) coupled to the digital signal processor;
a Bluetooth controller coupled to the digital signal processor;
a Bluetooth antenna coupled to the Bluetooth controller;
a wireless local area network media access control (WLAN MAC) baseband processor coupled to the digital signal processor;
an RF transceiver coupled to the WLAN MAC baseband processor; and
an RF antenna coupled to the RF transceiver.

27. The portable communication device of claim 18, further comprising:
a stereo coder/decoder (CODEC) coupled to the digital signal processor;
an 802.11 controller coupled to the digital signal processor;
an 802.11 antenna coupled to the 802.11 controller;
a Bluetooth controller coupled to the digital signal processor;
a Bluetooth antenna coupled to the Bluetooth controller;
a universal serial bus (USB) controller coupled to the digital signal processor; and
a USB port coupled to the USB controller.

28. An audio file player, comprising:
a digital signal processor;
an audio coder/decoder (CODEC) coupled to the digital signal processor;
a multimedia card coupled to the digital signal processor;
a universal serial bus (USB) port coupled to the digital signal processor; and
wherein the digital signal processor includes:
a memory unit;
a sequencer responsive to the memory unit;
at least one instruction execution unit responsive to the sequencer; and
at least one interleaved multi-threading instruction pipeline, wherein the interleaved multi-threading instruction pipeline utilizes a number of clock cycles that is less than an instruction issue rate for each of a plurality of program threads that are stored within the memory unit and that are to be executed using the interleaved multi-threading instruction pipeline.

29. A processor device, comprising:
means for decoding a first instruction of a first program thread, wherein the first instruction generates a predicate for a following instruction of the first program thread;
means for executing the first instruction of the first program thread to resolve a value of the predicate; and
means for updating a predicate register associated with the first program thread to include the value of the predicate before issuing the following instruction of the first program thread for execution.
